(19) United States
(12) Patent Application Publication
(10) Pub. No.: US 2020/0312350 A1
(43) Pub. Date: Oct. 1, 2020

(54) METHOD AND APPARATUS FOR DETECTING SOUND EVENT CONSIDERING THE CHARACTERISTICS OF EACH SOUND EVENT

(71) Applicant: Electronics and Telecommunications Research Institute, Daejeon (KR)

(72) Inventors: Woo-taek LIM, Daejeon (KR); Sang Won SUH, Daejeon (KR); Young Ho JEONG, Daejeon (KR)

(73) Assignee: Electronics and Telecommunications Research Institute, Daejeon (KR)

(21) Appl. No.: 16/561,824

(22) Filed: Sep. 5, 2019

(30) Foreign Application Priority Data
Mar. 29, 2019 (KR) 10-2019-0036972

(51) Int. Cl. G10L 25/30; G10L 19/26; G10L 15/32; G10L 15/10; G10L 15/02

(52) U.S. Cl. CPC G10L 25/30; G10L 19/26; G10L 15/02; G10L 15/10; G10L 15/32

(57) ABSTRACT

A sound event detection method includes receiving a sound signal and determining and outputting whether a sound event is present in the sound signal by applying a trained neural network to the received sound signal, and performing post-processing of the output to reduce an error in the determination, wherein the neural network is trained to early stop at an optimal epoch based on a different threshold for each of at least one sound event present in a pre-processed sound signal. That is, the sound event detection method may detect an optimal epoch to stop training by applying different characteristics for respective sound events and improve the sound event detection performance based on the optimal epoch.

### CROSS-REFERENCE TO RELATED APPLICATION(S)

This application claims the benefit of Korean Patent Application No. 10-2019-0036972, filed on Mar. 29, 2019, in the Korean Intellectual Property Office, the disclosure of which is incorporated herein by reference.

### BACKGROUND

### 1. Field of the Invention

One or more example embodiments relate to a method and apparatus for detecting a sound event considering the characteristics of each sound event, and more particularly, to technology for detecting an optimal epoch to stop training by applying different characteristics for respective sound events and improving the sound event detection performance based on the optimal epoch.

### 2. Description of the Related Art

A neural network may classify and recognize input data through a result of training through repetition of linear fitting, non-linear transform, and activation. Since it is difficult to optimize such a neural network, related research had not been developed for a long time. However, various algorithms have been recently studied to solve issues of pre-processing, optimization, and overfitting, and the research have been actively conducted with the introduction of graphics processing unit (GPU) operation.

For sound event recognition technology currently used, a study for verifying excellent features by extracting, from a sound signal, various feature values such as a Mel-frequency cepstral coefficient (MFCC), an energy, a spectral flux, and a zero crossing rate, and a study related to a Gaussian mixture model or rule based classification method have been principally performed. Recently, neural network based sound event detection technology is needed to improve such methods.

### SUMMARY

An aspect provides a sound event detection method that may train a neural network to an optimal epoch for early stopping, by monitoring a loss or an accuracy or an F-score by applying different criteria (for example, different thresholds) for respective sound events.

According to an aspect, there is provided a sound event detection method including receiving a sound signal and determining and outputting whether a sound event is present in the sound signal by applying a trained neural network to the received sound signal, and performing post-processing of the output to reduce an error in the determination, wherein the neural network may be trained to early stop at an optimal epoch based on a different threshold for each of at least one sound event present in a pre-processed sound signal.

The different threshold may be determined by analyzing an interval including a strong label based on a length of the strong label, when the strong label including an onset or an offset is present.

The neural network may be trained to early stop at an optimal epoch determined while monitoring an accuracy or a loss or an F-score based on the different threshold for each sound event.

The pre-processing may include upsampling, downsampling, and channel number conversion of the sound signal.

The post-processing may include modeling time series data or applying filtering for smoothing.

According to an aspect, there is provided a neural network training method including performing pre-processing of a sound signal, and training a neural network to early stop at an optimal epoch based on a different threshold for each of at least one sound event present in the pre-processed sound signal.

The different threshold may be determined by analyzing an interval including a strong label based on a length of the strong label, when the strong label including an onset or an offset is present.

The neural network may be trained to early stop at an optimal epoch determined while monitoring an accuracy or a loss or an F-score based on the different threshold for each sound event.

The pre-processing may include upsampling, downsampling, and channel number conversion of the sound signal.

According to an aspect, there is provided a sound event detection apparatus including a processor and a memory including computer-readable instructions, wherein, when the instructions are executed by the processor, the processor may be configured to determine and output whether a sound event is present in a received sound signal by applying a trained neural network to the sound signal, and perform post-processing of the output to reduce an error in the determination, and wherein the neural network may be trained to early stop at an optimal epoch based on a different threshold for each of at least one sound event present in a pre-processed sound signal.

The different threshold may be determined by analyzing an interval including a strong label based on a length of the strong label, when the strong label including an onset or an offset is present.

The neural network may be trained to early stop at an optimal epoch determined while monitoring an accuracy or a loss or an F-score based on the different threshold for each sound event.

The pre-processing may include upsampling, downsampling, and channel number conversion of the sound signal.

The post-processing may include modeling time series data or applying filtering for smoothing.

According to an aspect, there is provided an apparatus for training a neural network, the apparatus including a processor and a memory including computer-readable instructions, wherein, when the instructions are executed by the processor, the processor may be configured to perform pre-processing of a sound signal, and train a neural network to early stop at an optimal epoch based on a different threshold for each of at least one sound event present in the pre-processed sound signal.

The different threshold may be determined by analyzing an interval including a strong label based on a length of the strong label, when the strong label including an onset or an offset is present.

The neural network may be trained to early stop at an optimal epoch determined while monitoring an accuracy or a loss or an F-score based on the different threshold for each sound event.

The pre-processing may include upsampling, downsampling, and channel number conversion of the sound signal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a sound event detection apparatus for detecting a sound event according to an example embodiment;

FIG. 2 is a diagram illustrating early stopping of training according to an example embodiment; and

FIG. 3 is a flowchart illustrating a sound event detection method performed by a sound event detection apparatus according to an example embodiment.

### DETAILED DESCRIPTION

Hereinafter, example embodiments will be described in detail with reference to the accompanying drawings. The scope of the right, however, should not be construed as limited to the example embodiments set forth herein. Like reference numerals in the drawings refer to like elements throughout the present disclosure.

Various modifications may be made to the example embodiments. Here, the examples are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

The terminology used herein is for the purpose of describing particular embodiments only and is not intended to be limiting. As used herein, the singular forms are intended to include the plural forms as well, unless the context clearly indicates otherwise. It will be further understood that the terms “comprise” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

Hereinafter, the example embodiments will be described described in detail with reference to the accompanying drawings.

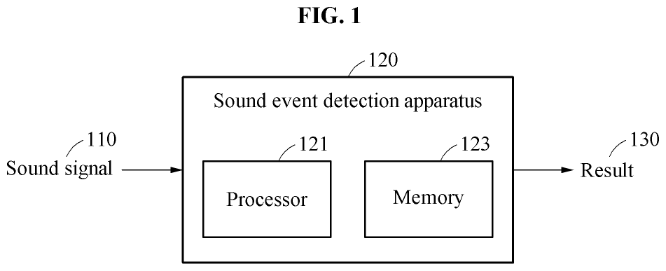

FIG. 1 is a diagram illustrating a sound event detection apparatus for detecting a sound event according to an example embodiment.

Technology for detecting and recognizing a sound event may be applied to various fields such as environment context recognition, dangerous situation recognition, media contents recognition, and wired and wireless communication situation analysis in real life.

Referring to FIG. 1, a sound event detection apparatus 120 for detecting a sound event from a sound signal may include a processor 121 and a memory 123. The memory 123 may include computer-readable instructions. When the instructions are executed by the processor 121, the processor 121 may detect the sound event from the sound signal by applying a trained neural network.

The sound event detection apparatus 120 may receive a sound signal 110, and display a result 130. In this example, the result 130 may indicate whether a sound event is present in a sound signal.

The sound event detection apparatus 120 may detect whether a sound event is present in the received sound signal by applying a trained neural network. Here, the neural network may be trained using a pre-processed sound signal, and the pre-processing may include at least one of upsampling, downsampling, and channel number conversion of the sound signal.

Further, the neural network may be trained using a support vector machine (SVM), a deep neural network (DNN), a convolution neural network (CNN), or a recurrent neural network (RNN). In this example, the neural network may include at least one layer, in detail, various layers such as convolutional layers, pooling layers, activation layers, dropout layers, and softmax layers.

In detail, the neural network may include a main neural network for recognizing a sound event and an auxiliary neural network for determining whether a sound event is present. In this example, the main neural network may include three convolutional layers and two fully-connected layers. Each of the convolutional layers may include 64 nodes formed of convolutional filters of 3*3 size, and use ReLU as an activation function. Further, the two fully-connected layers may each include 128 nodes, and use ReLU and sigmoid as activation functions. Further, the auxiliary neural network may include three convolutional layers and one time-axis fully-connected layer. Each of the convolutional layers may include 32 nodes formed of convolutional filters of 3*3 size, and use ReLU as an activation function. To obtain a result regarding whether a sound event is present for each frame in the convolutional layers of the auxiliary neural network, pooling may be performed with respect to a frequency axis while time-axis information is preserved.

Here, when training the neural network based on an epoch, the training may be early stopped to prevent overfitting. The epoch may be an interval for adjusting a weight of the neural network. In this example, when the training is to be early stopped, an epoch to early stop the training of the neural network may need to be determined. An optimal epoch for early stopping may be determined by monitoring a loss or an accuracy or an F-score by applying different characteristics (for example, lengths, sizes, frequencies, energies, or thresholds of sound events) for respective sound events. In this example, the optimal epoch may be an epoch when there is no performance improvement of a loss or an accuracy or an F-score monitored using validation data, in addition to training data. The neural network may be trained based on different characteristic, rather than training the neural network using the same condition without reflecting different characteristics for respective sound events. Thus, the sound event detection performance may improve through the neural network trained to early stop at the optimal epoch.

For example, when a sound event 1 has a characteristic of large energy and a sound event 2 has a characteristic of relatively small energy, a threshold corresponding to the sound event 1 may be high and a threshold corresponding to the sound event 2 may be relatively low. Here, a threshold may be a criterion for determining whether a corresponding sound event is present. Being greater than or equal to the threshold may indicate that a sound event is present, and being less than the threshold may indicate than a sound event is absent. Thus, when training is early stopped at an optimal epoch based on different thresholds determined to be suitable for characteristics of respective sound events, the sound event detection performance of the trained neural network may improve.

When a strong label including an onset or an offset is present, an interval including the strong label may be analyzed based on a length of the strong label, and different characteristics (for example, thresholds) for the respective sound events may be applied based on a result of the analysis. Here, the onset may be a time at which a sound event in an audio signal being time series data starts, and the offset may be a time at which the sound event ends. Further, the strong label may be data tagged with the onset and the offset corresponding to the sound event in the audio signal. Conversely, a weak label may be data not tagged with the onset and the offset corresponding to the sound event in the audio signal. The weak label may indicate a presence of the sound event, but may not indicate a start time and an end time of the sound event.

In this example, a different threshold criterion for each class may be performed for all sound events with respect to a determined value (for example, like 0.1, 0.2, . . . , 0.9), and a threshold showing an optimal result for each sound event may be set. Here, early stopping may be performed at an epoch showing a highest loss or F-score. In detail, it may be determined that a sound event is present when being greater than or equal to the threshold, and that a sound event is absent when being less than the threshold. In this example, the threshold may not be set uniformly, but a different threshold may be applied depending on a type of a sound event. For example, a threshold for a sound of a passing car may be set to “0.5”, a threshold for a sound of an object fall may be set to “0.7”, and a threshold for a human voice may be set to “0.3”. The thresholds set for the respective sound events may be applied to training of the neural network, and a threshold showing an optimal result (for example, a highest accuracy) may be determined.

In this example, a range, a rate, or a momentum for changing the threshold while an epoch proceeds may be adjusted as hyper parameters to efficiently apply the threshold. In detail, setting and updating the threshold may be performed at each epoch or check point set by the user. Like reducing a variance of a loss value through the hyper parameters such as the rate or the momentum when updating a weight when training the neural network, a variance of the threshold for determining whether a sound event is present or absent may be reduced through the rate or the momentum at each epoch or check point. For example, a highest accuracy may be exhibited when a threshold for a sound event A is “0.4” at a fifth check point, and a highest accuracy may be exhibited when a threshold for the sound event A is “0.7” at a sixth check point. In this example, a great variance of the threshold for each check point may not be desirable. Thus, when a rate “0.33” is applied to the difference (0.7−0.4=0.3) between the thresholds, the threshold for the sound event A may be determined to be “0.5(0.4+0.1)”, rather than “0.7”, at the sixth check point by reflecting only about “0.1(0.3*0.33=0.1)” in the threshold “0.4” determined at the fifth check point.

In addition, when a strong label is present, a characteristic such as an average length of each sound event may be identified based on labeling information. Further, since different characteristic values (for example, energies or Mel coefficients) may be extracted from an interval including a sound event and an interval not including a sound event, thresholds may be determined based on different characteristics for respective sound events.

In another example, in a case of a system for recognizing a strong label sound event using weakly labeled (onset/offset-unlabeled) data of a sound event, a sound event recognition model may be trained under the assumption that all audio frames include an event. In general, an audio signal includes a lot of weak labels, but includes relatively fewer strong labels. Thus, a strong label may need to be estimated using a weak label. For this, training may be performed under the assumption that all time frames include a sound event. For example, when analyzing frames of a 10-seocnd audio signal in a unit of 20 ms, the audio signal may be divided into 500 frames. When the 10-second audio signal is tagged with only a weak label indicating that a sound event A is present, training may be performed after assigning a pseudo strong label of “1” to all the frames, wherein the pseudo strong label of “1” may indicate that the sound event A is present with respect to all the frames from 0 seconds to 10 seconds.

However, sound events may be present in different lengths in an audio input, and there may be an event appearing in long length and an event appearing in short length. Thus, an output result may be monitored and reflected in threshold determination. Here, the length is merely an example of the characteristic, and the characteristic may also include an energy. In this example, a range, a rate, or a momentum for changing the threshold while an epoch proceeds may be adjusted as hyper parameters to efficiently apply the threshold.

When training is performed by applying the same threshold to all the frames after assigning the pseudo strong label to all the 500 frames, an error may occur. Thus, by reflecting characteristics (for example, lengths) for respective sound events, a better output result may be obtained. In detail, thresholds may be determined by reflecting different characteristics for respective sound events, and a better output result may be obtained by reflecting the thresholds. For example, when the length of the sound event A is less than or equal to 1 second and the length of the sound event B is greater than or equal to 5 seconds which is relatively long, the different characteristics may be reflected such that the threshold corresponding to the sound event A may be low and the threshold corresponding to the sound event B may be relatively high. In addition to the length, energy may also be a characteristic utilized for threshold determination. In another example, when applying a filter for smoothing as post-processing, the different characteristics may be reflected such that the filter length for the sound event A may be short and the filter length for the sound event B may be relatively long.

The sound event detection apparatus 120 may determine whether a sound event is present in each frame or segment of the sound signal by applying the trained neural network. Further, the sound event detection apparatus 120 performs post-processing for error removal to reduce an error in a result of determining whether a sound event is present. In detail, the sound event detection apparatus 120 may remove the error by modeling time series data or applying filtering for smoothing.

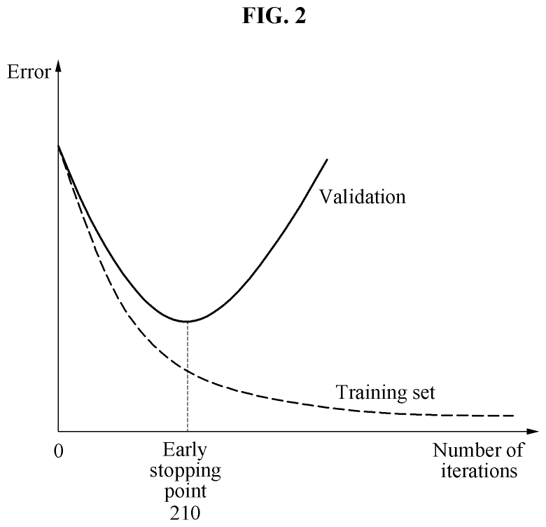

FIG. 2 is a diagram illustrating early stopping of training according to an example embodiment. Data used for training a neural network may include training data, and validation data to be used to verify a trained neural network. The validation data may be used to search for an optimal epoch for early stopping.

The epoch may be a period for adjusting a weight of the neural network. An axis X of FIG. 2 denotes the number of iterations of the epoch, and indicates the number of times the neural network is trained. Thus, as shown in FIG. 2, the neural network trained through training data may reduce the error (the axis Y) as the number of iterations increases. However, as shown in FIG. 2, when the validation data is applied to the neural network trained through the training data, the error (the axis Y) may increase again before and after an early stopping point 210 as a point of inflection. In this example, the early stopping point 210 being the point of inflection may indicate an epoch at which overfitting starts. Thus, the sound event detection performance of the neural network trained to an epoch corresponding to the early stopping point 210 may improve.

The early stopping point 210 may be determined by applying different characteristics for respective sound events while monitoring an error or a loss or an accuracy. The sound event detection performance of the neural network trained to an epoch corresponding to the early stopping point 210 may improve.

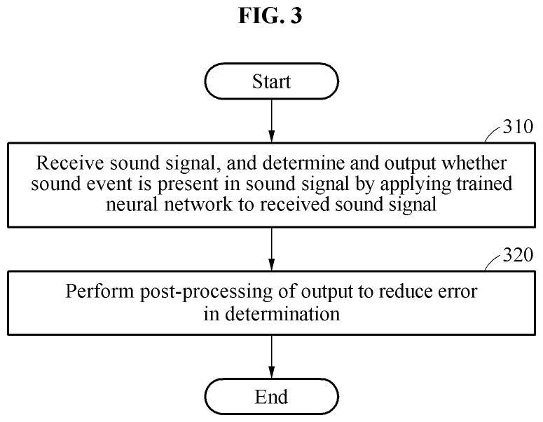

FIG. 3 is a flowchart illustrating a sound event detection method performed by a sound event detection apparatus according to an example embodiment.

In operation 310, a sound event detection apparatus may receive a sound signal, and determine and output whether a sound event is present in the sound signal by applying a trained neural network to the received sound signal.

In this example, a training apparatus may train the neural network to early stop at an optimal epoch based on a different threshold for each of at least one sound event present in a pre-processed sound signal. The training apparatus may be provided inside or outside of the sound event detection apparatus.

For example, when a sound event 1 has a characteristic of large energy and a sound event 2 has a characteristic of relatively small energy, a threshold corresponding to the sound event 1 may be high and a threshold corresponding to the sound event 2 may be relatively low. Here, a threshold may be a criterion for determining whether a corresponding sound event is present. Being greater than or equal to the threshold may indicate that a sound event is present, and being less than the threshold may indicate than a sound event is absent. Thus, when training is early stopped at an optimal epoch based on different thresholds determined to be suitable for characteristics of respective sound events, the sound event detection performance of the trained neural network may improve.

When a strong label including an onset or an offset is present, an interval including the strong label may be analyzed based on a length of the strong label, and different characteristics (for example, thresholds) for the respective sound events may be applied based on a result of the analysis.

For example, a different threshold criterion for each class may be performed for all classes with respect to a determined value (for example, like 0.1, 0.2, . . . , 0.9), and a threshold showing an optimal result for each class may be set. Here, early stopping may be performed at an epoch showing a highest loss or F-score. In this example, a range, a rate, or a momentum for changing the threshold while an epoch proceeds may be adjusted as hyper parameters to efficiently apply the threshold.

In another example, in a case of a system for recognizing a strong label sound event using weakly labeled (onset/offset-unlabeled) data of a sound event, a sound event recognition model may be trained under the assumption that all audio frames include an event. However, sound events may be present in different lengths in an audio input, and there may be an event appearing in long length and an event appearing in short length. Thus, an output result may be monitored and reflected in threshold determination. In this example, a range, a rate, or a momentum for changing the threshold while an epoch proceeds may be adjusted as hyper parameters to efficiently apply the threshold.

In operation 320, the sound event detection apparatus may perform post-processing of the output to reduce an error in the determination. In this example, the post-processing may include modeling time series data or filtering for smoothing.

A neural network may be trained to an optimal epoch for early stopping by monitoring a loss or an accuracy or an F-score by applying different criteria (for example, different thresholds) for respective sound events. Thus, the performance of detecting at least one sound event included in a sound signal may improve by applying the trained neural network.

According to example embodiments, a sound event detection method may use a neural network trained to an optimal epoch for early stopping by monitoring a loss or an accuracy or an F-score by applying different criteria (for example, different thresholds) for respective sound events. Thus, the performance of detecting at least one sound event included in a sound signal may improve by applying the trained neural network.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The apparatus described herein may be implemented using a hardware component, a software component and/or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A sound event detection method, comprising:
receiving a sound signal and determining and outputting whether a sound event is present in the sound signal by applying a trained neural network to the received sound signal; and
performing post-processing of the output to reduce an error in the determination,
wherein the neural network is trained to early stop at an optimal epoch based on a different threshold for each of at least one sound event present in a pre-processed sound signal.

2. The sound event detection method of claim 1, wherein the different threshold is determined by analyzing an interval including a strong label based on a length of the strong label, when the strong label including an onset or an offset is present.

3. The sound event detection method of claim 1, wherein the neural network is trained to early stop at an optimal epoch determined while monitoring an accuracy or a loss or an F-score based on the different threshold for each sound event.

4. The sound event detection method of claim 1, wherein the pre-processing comprises upsampling, downsampling, and channel number conversion of the sound signal.

5. The sound event detection method of claim 1, wherein the post-processing comprises modeling time series data or applying filtering for smoothing.

6. A neural network training method, comprising:
performing pre-processing of a sound signal; and
training a neural network to early stop at an optimal epoch based on a different threshold for each of at least one sound event present in the pre-processed sound signal.

7. The neural network training method of claim 6, wherein the different threshold is determined by analyzing an interval including a strong label based on a length of the strong label, when the strong label including an onset or an offset is present.

8. The neural network training method of claim 6, wherein the neural network is trained to early stop at an optimal epoch determined while monitoring an accuracy or a loss or an F-score based on the different threshold for each sound event.

9. The neural network training method of claim 6, wherein the pre-processing comprises upsampling, downsampling, and channel number conversion of the sound signal.

10. A non-transitory computer-readable storage medium storing instructions that, when executed by a processor, cause the processor to perform the sound event detection method of claim 1.

11. A sound event detection apparatus, comprising:
a processor and a memory including computer-readable instructions,
wherein, when the instructions are executed by the processor, the processor is configured to determine and output whether a sound event is present in a received sound signal by applying a trained neural network to the sound signal, and perform post-processing of the output to reduce an error in the determination, and
wherein the neural network is trained to early stop at an optimal epoch based on a different threshold for each of at least one sound event present in a pre-processed sound signal.

12. The sound event detection apparatus of claim 11, wherein the different threshold is determined by analyzing an interval including a strong label based on a length of the strong label, when the strong label including an onset or an offset is present.

13. The sound event detection apparatus of claim 11, wherein the neural network is trained to early stop at an optimal epoch determined while monitoring an accuracy or a loss or an F-score based on the different threshold for each sound event.

14. The sound event detection apparatus of claim 11, wherein the pre-processing comprises upsampling, downsampling, and channel number conversion of the sound signal.

15. The sound event detection apparatus of claim 11, wherein the post-processing comprises modeling time series data or applying filtering for smoothing.
